(19) United States
(12) Patent Application Publication
(10) Pub. No.: US 2009/0197046 A1
(43) Pub. Date: Aug. 6, 2009

(54) Sthikote

(75) Inventor: James Richard Buck, Jacksonville, FL (US)

Correspondence Address: James R. Buck, 8550 Hunters Creek Drive North, Jacksonville, FL, 32256-9062, US

(73) Assignee: James R. Buck, Jacksonville, FL (US)

(21) Appl. No.: 12/011,968

(22) Filed: Jan. 31, 2008

(51) Int. Cl. B32B 3/00

(52) U.S. Cl. 428/141

(57) ABSTRACT

STHIKOTE's slip resistant coating's unique method of surface preparation, machining, makes STHIKOTE's surface bond as needed, 100% of the time, and creates adhesion which allows for standard metal fabrication techniques to be used. Because the machining process does not distort the substrate which has the slip resistant coating applied as does existing products which use media blasting preparation, STHIKOTE can be attached to other materials as a coating separate from the thicker substrates needed by current processes which must use heavier materials to prevent warping when prepared for thermal spraying.

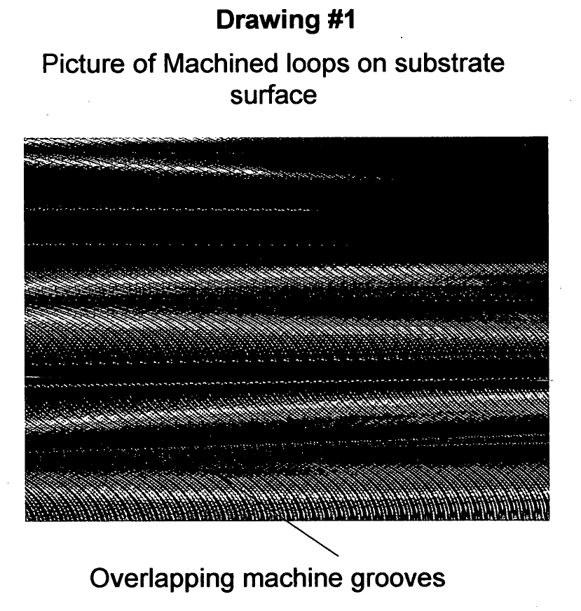

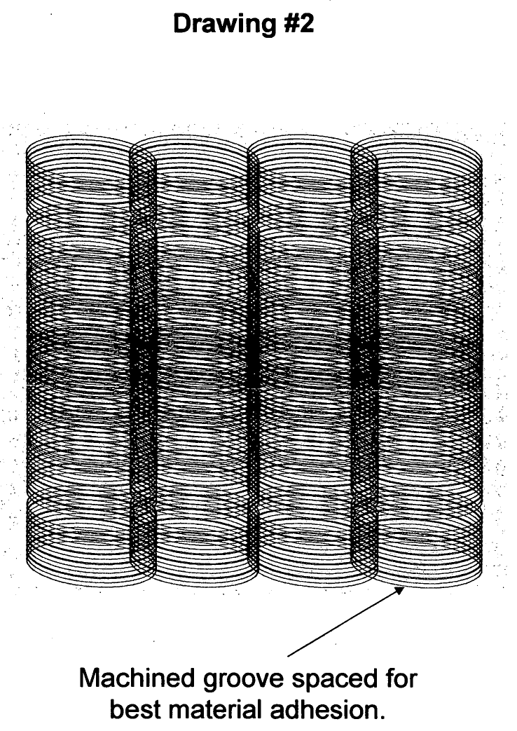

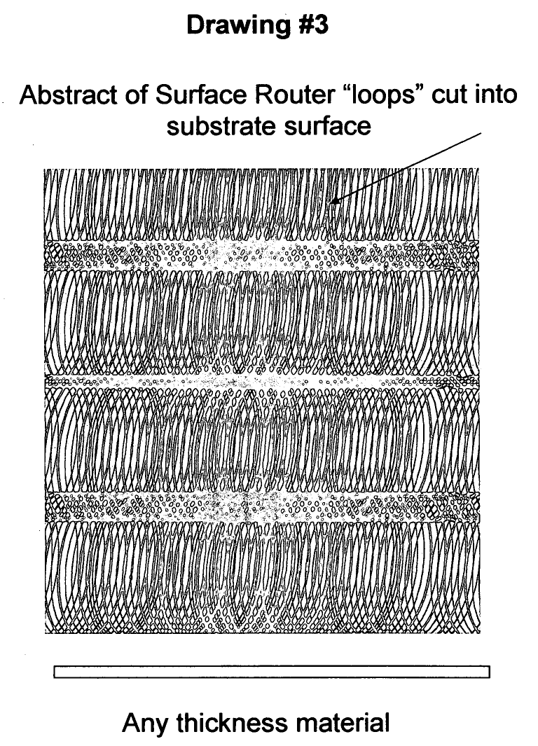

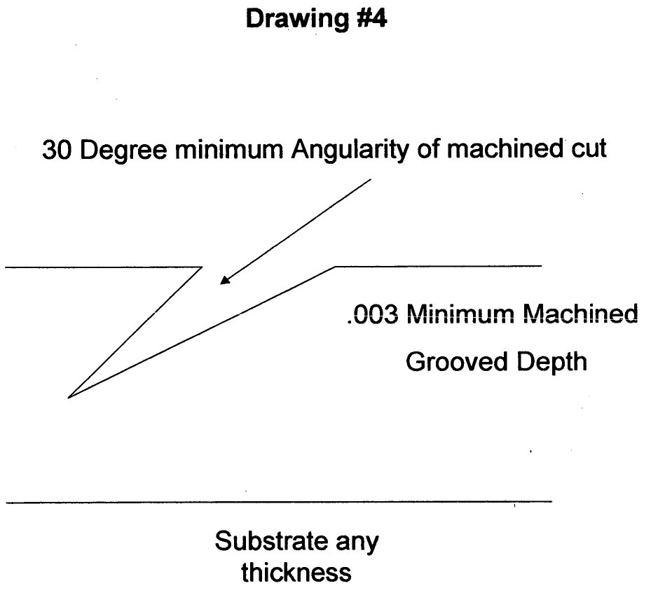

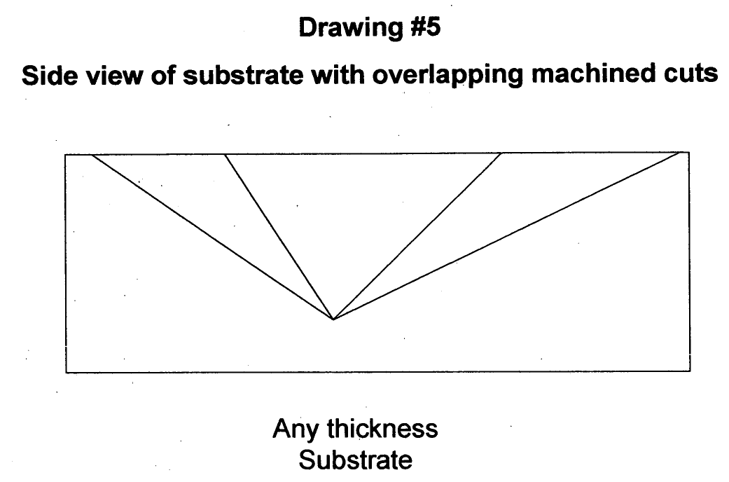

STHIKOTE is the product name given the process and product name given the items covered by this patent application and representations. It is for a slip resistant material coating. STHIKOTE's unique slip resistant surface is comprised of a machined substrate surface and thermally sprayed coatings.

Regardless of substrate thickness, a CNC router machining center is used to prepare the surface of a variety of substrates (aluminum, carbon steel, stainless steel, composite plastics and wood) to best accept thermally heated and sprayed material to create a slip-resistant surface with superior bonding adhesion. The coating also acts as a corrosion protection finish. The material to have the slip resistant coating applied to its surface is placed upon the work platform of a Computer Numeric Controlled (CNC) router table. The routing machine is programmed to machine the complete surface area of the substrate to be coated with the STHIKOTE process. Using a machine tool called a “facing cutter” and running at over 4,000 RPM's, the substrate surface if machined to have angled grooves, not less than 30 degrees, cut down below the surface of the substrate material, not less than 0.003 deep. Traveling at 800 inches per minutes, the tool cuts grooves at measured intervals while leaving small areas of the substrate's original surface un-cut between the machined grooves, no more than 0.025 wide from the center of one angled groove to the center of the next angled groove. Then, the substrate is sprayed with a thermally bonding material. The build-up of thermally sprayed materials into the height variances between the original surfaces of the substrate and the machined grooves creates slip resistant points. See drawing #1, page 3. Drawing #2, page 4, shows the machined grooves and the approximate spacing for the grooving. Drawing #3, page 5, shows the overlapping grooves. Drawing #4, page 6, is close-up of grooved surface preparation prior to thermal coating. Drawing #5, page 7, shows how the machined grooves touch to make high percentage of surface prepared for the thermal spraying. The same process performed on the material surface is performed on the bottom of the material if end product will be attached by adhesives to an additional surface for slip prevention.

Once the surface of the substrate is prepared, a dual wire arc thermal spraying machine is used to spray a combination of molten aluminum and molten stainless wire onto the prepared substrate. Using an aluminum wire of one diameter (0.120) and a stainless wire on another diameter, 0.090, the wire passes through the equipment for melting. The two wires have current passed through them and when they meet at the tip of the application device, an electrical short is created between the two ungrounded wires, causing them to melt. Once the material becomes molten from the electrical short, it is forced away from the melting point by compressed air through nozzle, blowing it away from the melting intersection onto the surface of the substrate. The molten spray being blown away from the nozzle of the twin arc machine by the air remains molten enough that it is forced into the machined grooves and flows into the voids created by machining. As the molten metal material cools, it anchors itself into the grooves, below and upon the material surfaces. Grooved angles “under-cut” into the substrate and give a superior bond to those products that use abrasive wheel blasting as the method of surface preparation. Once the processing is complete, the material can then be used in its finished condition, fabricated or attached to other surfaces for slip prevention.

### BACKGROUND OF INVENTION

The invention, STHIKOTE, has evolved from the production of existing slip resistant flooring products manufactured by spraying thermally heated metals onto other metal substrates to create a bonded coating which reduces potential slipping when someone walks on it. The need for STHIKOTE in the marketplace is that the production methods for the other known products are extremely expensive and costing to the potential users mostly eliminates a thermally sprayed product from most safety applications. STHIKOTE's higher production ability and quality adhesion compared to other slip resistant metal coatings keeps the market price lower than the competition, making the product more affordable to a larger number of customers than existing products.

The recommended U.S. patent Classification Definition should be 446.

### BRIEF SUMMARY OF THE INVENTION

STHIKOTE is the process and product name for a new, more cost effective method of producing a slip resistant surface on metal flooring and personnel accesses such as ladders, ramps, trench covers and utility access hatches. STHIKOTE is manufactured by machining the surface of the substrate to be coated with a metal spray combination of aluminum and stainless wire, heated to over 3,000 degree F. and blown with compressed air onto the machined surface. This process reduces the need for surface

blasting the substrates as is currently done, and gives the molten sprayed material a much better surface to adhere itself to when sprayed. The combination of surface machining rather than blasting improves the depth of the surface preparation compared to blasting, with more consistent profile than blasting and with a fraction of the cost of the capital equipment required to surface blast materials as is currently done for similar products. The capital investment required to produce STHIKOTE is in the thousands of dollars and to produce other similar products in the hundreds of thousands of dollars, making STHIKOTE a very cost effective product to produce. Other products produced by surface blasting prior to molten spraying often have their products fail from delimitation, a condition where the bonded metal separates from the prepared substrate, causing surface failure. STHIKOTE's machined surface causes the molten sprayed metal to flow into the angled machined voids created by the machining process, locking the metal to the surface of the substrate. STHIKOTE can be formed on conventional bending equipment using standard metal forming practices and all the other known metal sprayed slip resistant surfaces cannot.

### BRIEF DESCRIPTION OF DRAWINGS

Drawing 1A., though not to scale, shows the overlapping circle configuration created when the surface of the STHIKOTE product is machined. Drawing 1B., though also not to scale, shows the general machining angles into the surface of the substrate to lock the molten sprayed metal onto the surface, creating a slip resistant that has consistent material bond adhesion and predictable molten coating depths.

STHIKOTE is the product name given the process and product name given the items covered by this patent application and representations. It is for a slip resistant material coating. STHIKOTE's unique slip resistant surface is comprised of a machined substrate surface and thermally sprayed coatings.

Regardless of substrate thickness, a CNC router machining center is used to prepare the surface of a variety of substrates (aluminum, carbon steel, stainless steel, composite plastics and wood) to best accept thermally heated and sprayed material to create a slip-resistant surface with superior bonding adhesion. The coating also acts as a corrosion protection finish. The material to have the slip resistant coating applied to its surface is placed upon the work platform of a Computer Numeric Controlled (CNC) router table. The routing machine is programmed to machine the complete surface area of the substrate to be coated with the STHIKOTE process. Using a machine tool called a “facing cutter” and running at over 4,000 RPM's, the substrate surface if machined to have angled grooves, not less than 30 degrees, cut down below the surface of the substrate material, not less than 0.003 deep. (See drawing #1B) Traveling at 800 inches per minutes, the tool cuts grooves at measured intervals while leaving small areas of the substrate's original surface un-cut between the machined grooves, no more than 0.025 wide from the center of one angled groove to the center of the next angled groove. Then, the substrate is sprayed with thermally bonding material. The build-up of thermally sprayed material on the height variances between the original surfaces of the substrate and the machined grooves creates slip resistant points. (See drawing #1A) The same process performed on the material surface is performed on the bottom of the material if end product will be attached by adhesives to an additional surface for slip prevention.

Once the surface of the substrate is prepared, a dual wire arc thermal spraying machine is used to spray a combination of molten aluminum and molten stainless wire onto the prepared substrate. Using an aluminum wire of one diameter (0.120) and a stainless wire on another diameter, 0.090, the wire passes through the equipment for melting. The two wires have current passed through them and when they meet at the tip of the application device, an electrical short is created between the two ungrounded wires, causing them to melt. Once the material becomes molten from the electrical short, it is forced away from the melting point by compressed air through nozzle, blowing it away from the melting intersection onto the surface of the substrate. The molten spray being blown away from the nozzle of the twin arc machine by the air remains molten enough that it is forced into the machined grooves and flows into the voids created by machining. As the molten metal material cools, it anchors itself into the grooves, below and upon the material surfaces. Grooved angles “under-cut” into the substrate and give a superior bond to those products that use abrasive wheel blasting as the method of surface preparation. Once the processing is complete, the material can then be used in its finished condition, fabricated or attached to other surfaces for slip prevention.

1. STHIKOTE's machined surface preparation is unique. The configuration of the machined pattern and the angle of cutting to the substrate surface allow thermally sprayed slip resistant surface coatings to completely bond to the substrate.

2. STHIKOTE's machined surface, as compared to a “media blasted surface”, keeps the substrate material in a flat condition, not a distorted, warped, off of flat condition, as is caused by the media blasting. Media blasting causes the substrate materials to warp from the peening of the media. STHIKOTE can be applied to much thinner pieces of material, less than 0.120, as compared to other molten sprayed, slip resistant metal products.

3. STHIKOTE's machined surface creates 100 bonding of slip resistant materials allowing the material to be fabricated; cut and formed, as no other thermally sprayed slip resistant coating.
